(19) United States
(12) Patent Application Publication
(10) Pub. No.: US 2026/0034843 A1
(43) Pub. Date: Feb. 5, 2026

(54) TIRE INFLATION SYSTEM FOR HEAVY-DUTY VEHICLES

(71) Applicant: Hendrickson USA, L.L.C., Schaumburg, IL (US)

(72) Inventors: Matt J. Wilson, Canal Fulton, OH (US); Jesse W. Cervantez, Rocky Mount, VA (US); Jeffrey S. Morris, Canton, OH (US); Mark Gauer, Canal Fulton, OH (US); Nicholas R. Barbieri, Canton, OH (US)

(21) Appl. No.: 19/248,708

(22) Filed: Jun. 25, 2025

Related U.S. Application Data
(60) Provisional application No. 63/669,263, filed on Jul. 10, 2024.

(51) Int. Cl. B60C 29/06; B60C 23/00

(52) U.S. Cl. CPC B60C 29/068; B60C 23/001

(57) ABSTRACT

A mechanical fluid pressure regulator comprising a regulator portion for housing components of a valve assembly, a pilot port for receiving a control pressure, an exhaust port, and first and second structures disposed within the regulator. The regulator portion has a supply port for receiving a supply pressure and a delivery port for providing a delivery pressure, the delivery port being in selective fluid communication with the supply port. The at least one exhaust port is in selective fluid communication between the delivery port and the external environment. The first structure is adjustable for establishing a maximum threshold pressure without regard to the control pressure. The second structure affects the response of the regulator portion to the supply and delivery pressures. The control pressure cooperates with the first and second structures to proportionally reduce the delivery pressure from the maximum threshold pressure established by the first structure.

### CROSS-REFERENCE TO RELATED APPLICATION

This application claims the benefit of U.S. Provisional Patent Application No. 63/669,263, filed Jul. 10, 2024.

### BACKGROUND OF THE INVENTION

### Field of the Invention

The present invention relates generally to tire inflation systems for heavy-duty vehicles. In particular the present invention relates to tire inflation systems for heavy-duty vehicles incorporating fluid pressure regulators responsive to control pressure input. More particularly, the present invention relates to a tire inflation system for heavy-duty vehicles incorporating a pilot-operated, fluid pressure regulator that has an adjustable maximum threshold pressure and that is capable of reducing the pressure output delivered to tire and wheel assemblies by an amount equal or proportional to the control pressure.

### Background Art

The use of tire inflation systems in heavy-duty vehicles is well-known. For the purposes of clarity and convenience, reference is made to a heavy-duty vehicle with the understanding that such reference includes trucks, tractor-trailers or semi-trailers, trailers, and the like. A heavy-duty vehicle typically includes multiple tires requiring inflation with air to target pressures for optimal performance. The relatively large number of tires on any given heavy-duty vehicle configuration makes it difficult to manually check and maintain the optimal tire pressure for each and every tire. This difficulty is compounded by the fact that heavy-duty vehicles in a fleet may be located at a site for an extended period of time, during which the tire pressure might not be checked. Any one of these heavy-duty vehicles might be placed into service at a moment's notice, leading to the possibility of operation with under-inflated tires. Operating heavy-duty vehicles with under-inflated tires may adversely affect the performance and service life of the tires, potentially resulting in damage and/or failure of the tires.

Prior art tire inflation systems have been developed to maintain the tires of heavy-duty vehicles at a target pressure. Prior art tire inflation systems typically operate by inflating tires with air from an air supply using a variety of different components, arrangements, and/or methods. For instance, some prior art tire inflation systems have utilized prior art pilot-operated regulators designed to increase fluid flow or delivery pressure to the tires based on a control signal or pilot pressure. In particular, prior art pilot-operated regulators generally have a one-to-one (1:1) relationship between the pilot pressure and the delivery pressure such that the pilot pressure increases the delivery pressure to match the pilot pressure. As a result, prior art tire inflation systems generally require relatively high pilot pressures. Some prior art pilot-operated regulators may have alternative ratios of pilot pressure to delivery pressure other than one-to-one, such that increasing pilot pressure to the pilot-operated regulator increases delivery pressure by a fraction or multiple of one. Prior art tire inflation systems may also deflate the tires when the monitored pressure rises above the target pressure by exhausting air from the tire and wheel assemblies to atmosphere.

Some prior art tire inflation systems may rely on electronic controls, including processors, microchips, electronic control units (ECUs), or the like to execute relatively complex algorithms and to perform calculations utilized in determining appropriate target pressures for the heavy-duty vehicle tires. In addition, prior art tire inflation systems with electronic controls generally utilize electronically-actuated solenoid valves to control fluid flow and inflation and deflation of the tires. Such electronic controls generally require the use of, and may be adversely affected by, the electrical system of the heavy-duty vehicle.

While satisfactory for their intended purpose, prior art tire inflation systems have limitations, disadvantages, and drawbacks. For instance, as discussed above, prior art tire inflation systems with electronic controls generally require the use of, and may potentially affect the operation of, the heavy-duty vehicle electrical system. Any issues with the heavy-duty vehicle electrical system may potentially cause a fault in the electronic controls, resulting in a loss of pilot pressure to the prior art pilot-operated regulator, thereby reducing the delivery pressure, and thus the fluid pressure in the tires such that the heavy-duty vehicle may operate with under-inflated tires, potentially causing damage to, decreasing the performance of, increasing or causing irregular wear of, and/or reducing the service-life of the tires.

In addition, because prior art tire inflation systems generally require relatively high pilot pressures, solenoid valves and other components utilized with electronic controls for prior art tire inflation systems must generally be designed for the typical supply pressures available in heavy-duty vehicles, such as about 105 to 125 psi. Moreover, such solenoid valves and other components utilized in prior art tire inflation systems must be durable enough to undergo an extreme number of cycles, typically millions, at relatively high pressures over the course of the service life of the solenoids and other components. As a result, such solenoid valves and other components of prior art tire inflation systems with electronic controls are typically heavy-duty and complex, increasing the weight and overall complexity of the prior art tire inflation systems.

Thus, there is a need for a tire inflation system with electronic controls utilizing a mechanical regulator that automatically and continuously adjusts and maintains fluid pressure in the tires, reducing the fluid pressure proportionally in response to a control pressure and maintaining the fluid pressure in the tires at a pre-selected maximum threshold pressure in the event of a loss of electrical power, or in the absence of control pressure, to prevent operation of the heavy-duty vehicle with under-inflated tires, increasing fuel economy of the heavy-duty vehicle; reducing wear on, preventing damage to, and increasing the service-life of the tires; and reducing the weight, complexity, and cost of the tire inflation system.

### SUMMARY OF THE INVENTION

Objectives of the present invention include providing a tire inflation system with electronic controls utilizing a mechanical regulator that automatically and continuously adjusts and maintains fluid pressure in the tires.

A further objective of the present invention is to provide a tire inflation system with electronic controls utilizing a mechanical regulator that reduces the fluid pressure in the tires proportionally in response to a control pressure.

Yet another objective of the present invention is to provide a tire inflation system with electronic controls utilizing a mechanical regulator that maintains the fluid pressure in the tires at a pre-selected maximum threshold pressure in the event of a loss of electrical power or control pressure, preventing operation of the heavy-duty vehicle with under-inflated tires.

These objectives and advantages are obtained by the mechanical fluid pressure regulator, according to the present invention, the regulator comprising a regulator portion for housing components of a valve assembly, a pilot port for receiving a control pressure, at least one exhaust port, and first and second structures disposed within the regulator. The regulator portion has a supply port for receiving a supply pressure and a delivery port for providing a delivery pressure, the delivery port being in selective fluid communication with the supply port. The at least one exhaust port being in selective fluid communication between the delivery port and the environment. The first structure being adjustable for establishing a maximum threshold pressure without regard to the control pressure. The second structure affects the response of the regulator portion to the supply and delivery pressures. The control pressure cooperates with the first and second structures to proportionally reduce the delivery pressure from the maximum threshold pressure established by the first structure.

Another aspect of the present invention provides a tire inflation system for heavy-duty vehicles, the tire inflation system comprising a source of fluid pressure, a tire and wheel assembly, and a mechanical regulator in fluid communication with the source of fluid pressure and the tire and wheel assembly. The mechanical regulator comprises a regulator portion for housing components of a valve assembly, a pilot port for receiving a control pressure, at least one exhaust port, a first structure disposed within said regulator, and a second structure disposed within said regulator. The regulator portion has a supply port for receiving a supply pressure and a delivery port for providing a delivery pressure to the tire and wheel assembly. The delivery port is in selective fluid communication with the supply port. The exhaust port is in selective fluid communication between the delivery port and the external environment. The first structure is adjustable for establishing a maximum threshold pressure for the tire and wheel assembly without regard to the control pressure. The second structure affects the response of the regulator portion to the supply and delivery pressures. The control pressure cooperates with the first and second structures to proportionally reduce the delivery pressure from the maximum threshold pressure established by the first structure.

### BRIEF DESCRIPTION OF THE SEVERAL VIEWS OF THE DRAWINGS

The preferred embodiment of the present invention, illustrative of the best mode in which Applicant has contemplated applying the principles, is set forth in the following description, shown in the drawings, and particularly and distinctly pointed out and set forth in the appended claims.

FIG. 1 is a schematic of an exemplary embodiment tire inflation system, according to the present invention;

FIG. 2 is an elevational view, in section, of the pilot-operated regulator shown in FIG. 1;

FIG. 3 is an elevational view, in section, of the pilot-operated regulator shown in FIGS. 1-2, showing the regulator in the supply condition;

FIG. 4 is an elevational view, in section, of the pilot-operated regulator shown in FIGS. 1-3, showing the regulator in the supply condition with pilot pressure applied;

FIG. 5 is an elevational view, in section, of the pilot-operated regulator shown in FIGS. 1-4, showing the regulator in the balanced condition; and

FIG. 6 is an elevational view, in section, of the pilot-operated regulator shown in FIGS. 1-5, showing the regulator in the exhaust condition.

Similar reference characters refer to similar parts throughout.

### DESCRIPTION OF THE PREFERRED EMBODIMENT

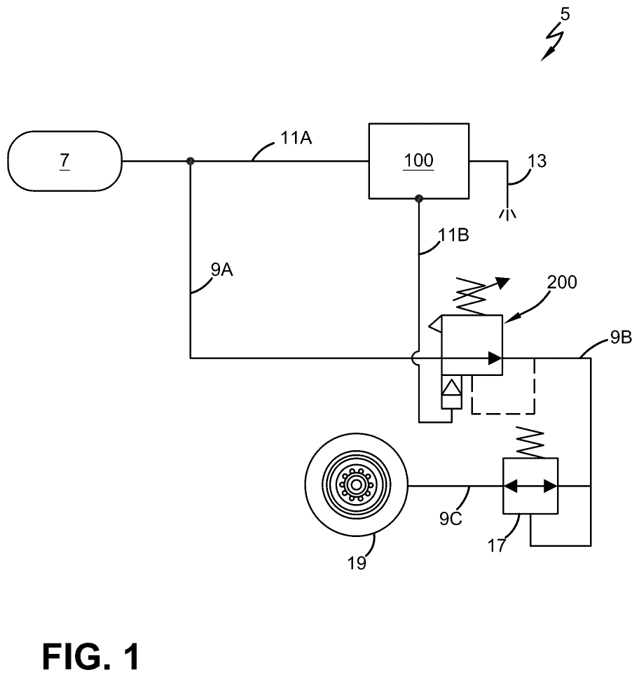

An exemplary embodiment heavy-duty vehicle tire inflation system 5 (FIG. 1), according to the present invention, may be an electronically-controlled, constant pressure tire inflation system. Tire inflation system 5 may include a source of fluid pressure 7, such as compressed air or nitrogen that may be stored in a pressure vessel or reservoir or supplied by a compressor, as is known.

Source of fluid pressure 7 may be in selective fluid communication with a tire and wheel assembly 19 of a heavy-duty vehicle (not shown) through any suitable tubing or conduit system, such as supply conduit portions 9A, 9B, 9C, that may extend through an axle (not shown) of the heavy-duty vehicle. It is also contemplated that the axle of the heavy-duty vehicle may serve as at least part of the conduit system. Source of fluid pressure 7 may be sufficiently sized in volume and maintained at a fluid pressure above the maximum expected fluid pressure in tire and wheel assembly 19, herein referred to as the maximum threshold pressure, to provide tire inflation system 5 with sufficient pressure and volume to quickly inflate the tire and wheel assembly. The maximum threshold pressure for tire and wheel assembly 19 may correspond to the pressure in the tire and wheel assembly where the tire and wheel assembly is at its maximum load rating or may correspond to the pressure in the tire and wheel assembly where the axle/suspension system (not shown) of the heavy-duty vehicle is at its maximum legal load. It is also contemplated that source of fluid pressure 7 may be sized to operate other components and systems of the heavy-duty vehicle, such as, air-actuated brakes (not shown) and/or air springs (not shown), in addition to tire inflation system 5.

Tire inflation system 5 may include a respective wheel valve 17 in fluid communication between source of fluid pressure 7 and tire and wheel assembly 19. More specifically, wheel valve 17 may be separately disposed along and in fluid communication with source of fluid pressure 7 through conduit portions 9A, B. Wheel valve 17 may also be in fluid communication with tire and wheel assembly 19 through conduit portion 9C. Wheel valve 17 may be capable of isolating each tire of tire and wheel assembly 19 from the rest of tire inflation system 5 in the event of, for example, a leak in another tire or somewhere in the tire inflation system. Wheel valve 17 may actuate or open at a pre-selected pressure setting or pressure level below any likely inflation pressure of tire and wheel assembly 19, enabling additional pressure and fluid flow to the tire and wheel assembly, thereby inflating the tire and wheel assembly, as is known.

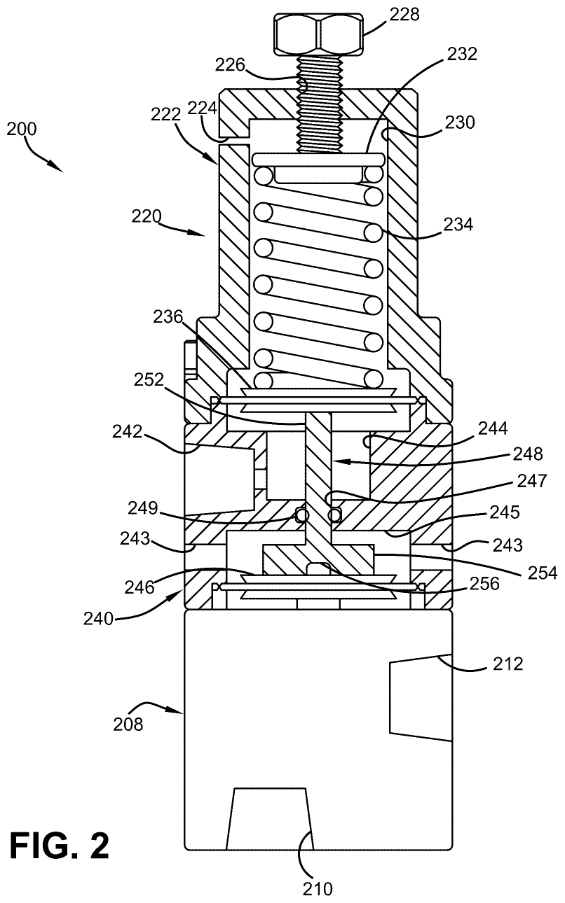

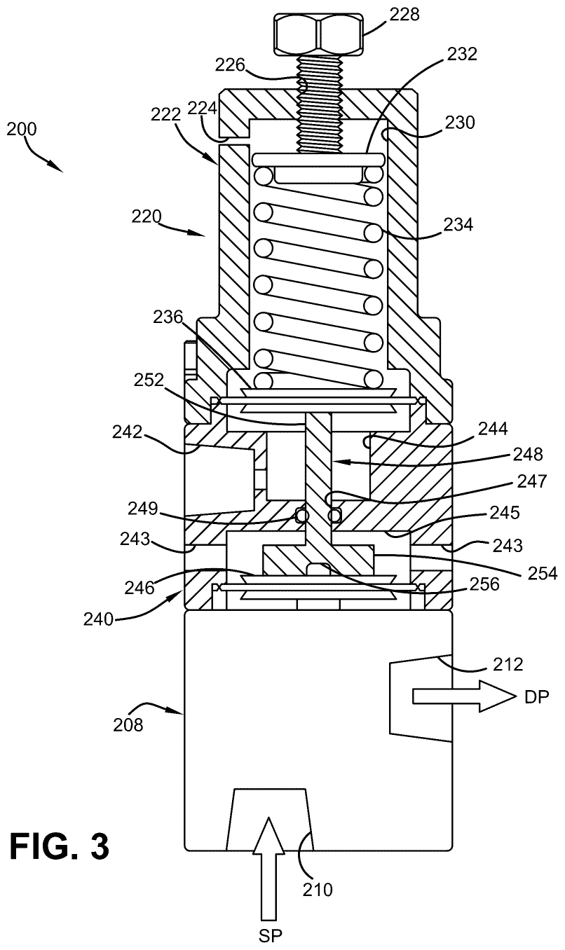

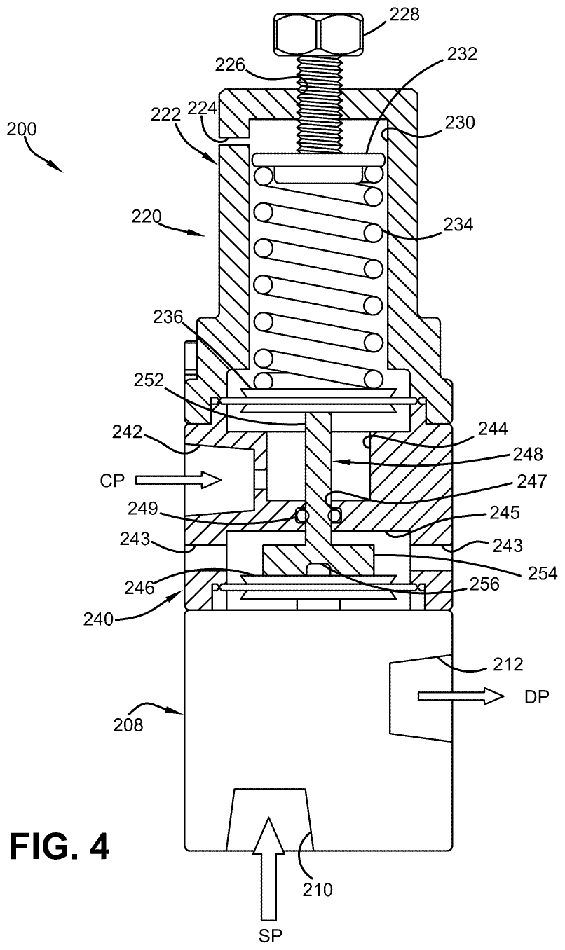

In accordance with an important aspect of the present invention, tire inflation system 5 may also include a pilot-operated regulator 200 (FIG. 2) in fluid communication between source of fluid pressure 7 and wheel valve 17. More specifically, source of fluid pressure 7 may provide fluid flow or a fluid supply pressure SP (FIG. 3) to regulator 200 through supply conduit portion 9A. Regulator 200, in turn, may establish and output fluid flow or a fluid delivery pressure DP as a function of a control pressure CP (FIG. 4), selectively controlling the fluid flow to and fluid pressure of tire and wheel assembly 19 through supply conduit portions 9B, C and wheel valve 17. Regulator 200 may be formed as a multi-stage or multi-section relieving regulator having a regulator section 208, a manual operation section 220, and an intermediate pilot or control section 240. Regulator section 208 may include an upper, open-end portion, to which intermediate control section 240 may be attached by any suitable means, such as a threaded connection. Similarly, manual operation section 220 may be attached to an upper portion of intermediate control section 240 by any suitable means, such as a threaded connection. Regulator section 208, intermediate control section 240, and manual operation section 220 may have respective cylindrical inner surface portions defining respective cavities that may generally be arranged coaxially. It is also contemplated that regulator section 208, intermediate control section 240, and manual operation section 220 could be formed as a single component.

Regulator section 208 may include a supply port 210 connected to or engaged with supply conduit portion 9A and in fluid communication with source of fluid pressure 7, providing fluid flow or supply pressure SP to the supply port. Regulator section 208 may also include an outlet or delivery port 212 connected to or engaged with supply conduit portion 9B to supply fluid flow or delivery pressure DP to tire and wheel assembly 19 through wheel valve 17 and supply conduit portion 9C. A valve arrangement or assembly (not shown) may be supported within regulator section 208, as is known, between supply port 210 and delivery port 212. The valve assembly may be of any suitable type, such as poppet or the like, and may selectively allow or block fluid communication between supply port 210 and delivery port 212, as is known. The valve assembly may also include a component, such as an exhaust portion (not shown) of a poppet, that selectively allows or blocks fluid communication between delivery port 212 and components of intermediate control section 240, as described below.

In accordance with another important aspect of the present invention, intermediate control section 240 includes structure for engaging and/or controlling the valve assembly housed within regulator section 208. In particular, intermediate control section 240 may include a pilot chamber 244 and an adjacent exhaust chamber 245. An opening 247 may be formed and extend between pilot chamber 244 and exhaust chamber 245. Intermediate control section 240 may be formed with a pilot port 242 extending from pilot chamber 244 to the exterior of the intermediate control section and providing fluid flow or control pressure CP between source of fluid pressure 7 and the pilot chamber through any suitable tubing or conduit system, such as pilot conduit portions 11A, B. Intermediate control section 240 may also be formed with one or more exhaust ports or vents 243 extending from and providing fluid communication between exhaust chamber 245 and the external environment. Intermediate control section 240 may house a plunger 248 disposed within pilot chamber 244 and extending through opening 247 into exhaust chamber 245. More specifically, plunger 248 may extend between and abut or engage a regulator diaphragm 246 and an upper or pilot diaphragm 236. More particularly, plunger 248 may be formed from any suitable material, such as metal or plastic, with a stem 252 and a head 254. Head 254 may be formed with any suitable shape but is preferably forked such that the center portion of the head includes a gap 256. Head 254 may abut or engage the upper surface of regulator diaphragm 246. Regulator diaphragm 246 may be formed from any suitable flexible material or materials, such as elastomer, and may be disposed between and separate regulator section 208 from intermediate control section 240. The lower surface of regulator diaphragm 246 may also engage a component of, or otherwise control the position and condition of, the valve assembly within regulator section 208. Stem 252 of plunger 248 may be generally continuous with and extend axially away from head 254 through exhaust chamber 245 and opening 247 into pilot chamber 244. A seal or O-ring 249 may be disposed about stem 252 and within opening 247 to provide a seal preventing fluid communication between pilot chamber 244 and exhaust chamber 245 while allowing movement of plunger 248. An upper portion of stem 252 may abut or engage the lower surface of pilot diaphragm 236, which may be disposed between and separate intermediate control section 240 from manual operation section 220. Pilot diaphragm 236 may be formed from any suitable flexible material or materials, such as elastomer. It is also contemplated that pistons may be utilized in place of diaphragms 236, 246.

In accordance with an important aspect of the present invention, manual operation section 220 of regulator 200 may include structure for selecting or adjusting the maximum threshold pressure for tire and wheel assembly 19. In particular, manual operation section 220 may include a bonnet 222 formed from any suitable material, such as metal, with an opening or vent 224 formed through a side of the bonnet to equalize pressure between an internal chamber 230 of the bonnet and the external environment, as is known. Bonnet 222 may include a threaded opening 226 for threadably receiving an adjustment screw 228 rotatably disposed within the opening. Adjustment screw 228 may be integrally formed with or abut a platform, piston, or spring seat 232 disposed within chamber 230 adjacent an end of the adjustment screw. Spring seat 232 may engage or abut an upper end of a coiled adjustment spring 234 disposed within and extending axially along at least a portion of chamber 230. Spring 234 may provide any suitable compression or spring force, as is known. A lower end of spring 234 axially opposite spring seat 232 may be in contact with or engage the upper surface of pilot diaphragm 236.

Rotation of adjustment screw 228 may alter the working height of spring 234, increasing the force reacting against spring seat 232, attempting to move or compress the spring downwardly, which, in turn, attempts to move pilot diaphragm 236 downwardly. The position of pilot diaphragm 236 established by adjustment screw 228, spring seat 232, and spring 234 establishes the maximum threshold pressure that regulator 200 may provide to tire and wheel assembly 19. More particularly, and as discussed above, pilot diaphragm 236 abuts or engages stem 252 of plunger 248 within intermediate control section 240. As a result, downward movement or deflection of pilot diaphragm 236 applies a force to stem 252, and thus plunger 248, attempting to move the plunger downwardly. Downward movement of plunger 248, in turn, applies a force to regulator diaphragm 246, attempting to move the regulator diaphragm downwardly against a force generated by fluid flow through or delivery pressure DP within regulator section 208. Because regulator diaphragm 246 abuts or engages with a component of the valve assembly within regulator section 208, downward movement of the regulator diaphragm opens and alters the response of the valve assembly to fluid flow or delivery pressure DP, such that the more the regulator diaphragm is deflected downwardly the greater the fluid flow through the valve assembly and the greater delivery pressure DP must be to oppose the regulator diaphragm. Thus, delivery pressure DP and the maximum threshold pressure in tire and wheel assembly 19 are increased. Therefore, when no control pressure CP has been introduced into pilot chamber 244, such as in the event electrical power to tire inflation system 5 is disrupted, the tire inflation system may continue to operate with pressure in tire and wheel assembly 19 defaulting to the maximum threshold pressure set by adjustment screw 228. The maximum threshold pressure may typically be a value corresponding to the pressure at which the tire achieves its maximum load rating or the pressure at which the suspension achieves its maximum legal load, such as from about 95 psi to about 125 psi, more preferably from about 105 psi to about 125 psi. It is contemplated that different spring rates may be selected for spring 234 in order to provide less variability in the maximum threshold pressure.

In accordance with another important aspect of the present invention, source of fluid pressure 7 may also be in selective fluid communication with regulator 200 through pilot conduit portions 11A, 11B, to provide control pressure CP to the regulator. Pilot conduit portion 11A may provide fluid communication between source of fluid pressure 7 and an electronically-controlled, electro-pneumatic signal generator or modulator 100. More specifically, source of fluid pressure 7 may provide fluid flow or supply pressure SP to modulator 100 through supply conduit portion 11A. Modulator 100, in turn, may selectively control fluid flow to, and establish control pressure CP for, regulator 200 through any suitable means, such as pilot conduit portion 11B.

In accordance with an important aspect of the present invention, modulator 100 may be generally configured to selectively provide fluid flow or control pressure CP to regulator 200. In particular, modulator 100 may be electronically-controlled to provide fluid flow or control pressure CP to regulator 200 or may exhaust the control pressure from the regulator, decreasing or increasing fluid pressure in tire and wheel assembly 19, respectively, in order to achieve an optimal pressure for a particular status, condition, or property of components of the heavy-duty vehicle, such as wheel speed, air spring pressure, tire pressure, supply pressure SP, lift axle position, cargo weight or axle load, or the like. More particularly, fluid flow or control pressure CP may be transmitted from modulator 100 through pilot conduit portion 11B and pilot port 242 into pilot chamber 244 of intermediate control section 240, generating a force within the pilot chamber that acts upwardly against pilot diaphragm 236 and offsets the force generated by adjustment screw 228 and spring 234. As a result, the deflection of pilot diaphragm 236 is reduced, altering the position of plunger 248, which reduces the deflection of regulator diaphragm 246, thereby causing the valve assembly within regulator section 208 to respond to a proportionally reduced delivery pressure DP.

In accordance with another important aspect of the present invention, and with particular reference to FIGS. 3-6, regulator 200 may have various operating conditions. In a fill state or supply condition of regulator 200, as shown in FIGS. 3-4, fluid flow, the magnitude and direction of which are indicated by arrows, occurs from supply port 210 through the valve assembly of regulator section 208 and out of delivery port 212 to inflate tire and wheel assembly 19. The supply condition of regulator 200 generally occurs when the fluid pressure in tire and wheel assembly 19, and thus delivery pressure DP, is either less than an ECU-determined optimal pressure for the tire and wheel assembly or is less than the maximum threshold pressure, such as when the heavy-duty vehicle has been parked for an extended period of time. Where no control pressure CP is introduced into pilot chamber 244 of intermediate control section 240, as shown in FIG. 3, if fluid pressure in tire and wheel assembly 19, and thus delivery pressure DP, is less than the maximum threshold pressure set by adjustment screw 228, regulator diaphragm 246 will be deflected downwardly by the force of the adjustment screw, spring 234, and pilot diaphragm 236, acting on the regulator diaphragm through plunger 248. Regulator diaphragm 246, in turn, will exert a force on a component of the valve assembly within regulator section 208, opening the valve assembly and providing fluid flow from supply port 210 to delivery port 212. The valve assembly of regulator section 208 will continue to provide fluid flow from supply port 210 to delivery port 212 until fluid pressure in tire and wheel assembly 19 achieves the maximum threshold pressure and delivery pressure DP balances the force from adjustment screw 228, spring 234, pilot diaphragm 236, and plunger 248, acting on regulator diaphragm 246. At that time, regulator diaphragm 246 will move upwardly, returning to a non-bowed, neutral, or balanced, position such that the valve assembly closes, blocking fluid flow from supply port 210 to delivery port 212, thereby placing regulator 200 in a balanced state or condition.

Similarly, where the ECU has determined an optimal pressure for tire and wheel assembly 19 and control pressure CP has been introduced into pilot chamber 244, as shown in FIG. 4, the control pressure acts upwardly on pilot diaphragm 236, opposing the force of adjustment screw 228 and spring 234, reducing the downward deflection of the pilot diaphragm. Because stem 252 of plunger 248 abuts or engages pilot diaphragm 236, reduced deflection of the pilot diaphragm allows head 254 of the plunger to shift upward, which, in turn, reduces the downward deflection of regulator diaphragm 246. As a result, the component of the valve assembly in regulator section 208 alters the response of the valve assembly to delivery pressure DP, as discussed above. If fluid pressure in tire and wheel assembly 19, and thus delivery pressure DP, is less than the ECU-determined optimal pressure, the delivery pressure will be unable to counter the force of regulator diaphragm 246 such that the valve assembly will open, providing fluid flow from supply port 210 to delivery port 212. The valve assembly will continue to provide fluid flow from supply port 210 to delivery port 212 until fluid pressure in tire and wheel assembly 19 achieves the optimal pressure and delivery pressure DP balances the force from adjustment screw 228; spring 234; pilot diaphragm 236, as opposed by control pressure CP; and plunger 248, acting on regulator diaphragm 246. At that time, regulator diaphragm 246 will move upwardly, returning to a non-bowed, neutral or balanced, position such that the valve assembly closes, blocking fluid flow from supply port 210 to delivery port 212, once again placing regulator 200 in the balanced condition.

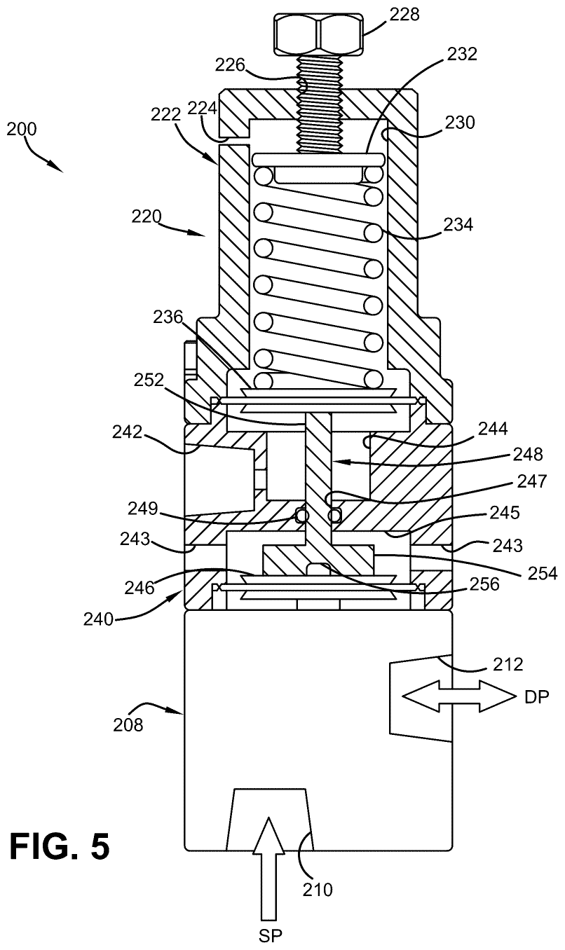

In the balanced condition of regulator 200, as shown in FIG. 5, no fluid flow occurs from supply port 210 through the valve assembly and out of delivery port 212 or from the delivery port to exhaust vents 243. The balanced condition of regulator 200 generally occurs when the pressure in tire and wheel assembly 19 is at or slightly above either the ECU-determined optimal pressure for a given condition of the heavy-duty vehicle or the maximum threshold pressure, such that there is no demand for fluid flow and fluid delivery pressure DP from the delivery port 212 to the tire and wheel assembly. In the balanced condition, delivery pressure DP may act on regulator diaphragm 246, attempting to move the diaphragm upwardly, which would also affect a component of the valve assembly, and thus the response of the valve assembly to the delivery pressure. However, in the balanced condition of regulator 200, the force generated by delivery pressure DP against regulator diaphragm 246 is counteracted by the sum of forces generated by components within intermediate control section 240 and manual operation section 220. In particular, plunger 248 may act downwardly against regulator diaphragm 246, countering the force generated by delivery pressure DP against the diaphragm. More particularly, the rotational position of adjustment screw 228 within opening 226 of bonnet 222 of manual operation section 220 generates a force acting on or compressing spring 234 through spring seat 232. Spring 234, in turn, may act on pilot diaphragm 236, attempting to move the diaphragm, and thus plunger 248, downwardly. In the balanced condition, regardless of whether control pressure CP has been introduced, the force of adjustment screw 228, spring 234, and pilot diaphragm 236, acting through plunger 248 against regulator diaphragm 246 negates the force generated by delivery pressure DP acting upwardly against the regulator diaphragm, thereby preventing the valve assembly within regulator section 208 from providing fluid communication between supply port 210 and delivery port 212 as well as between the delivery port and exhaust vents 243.

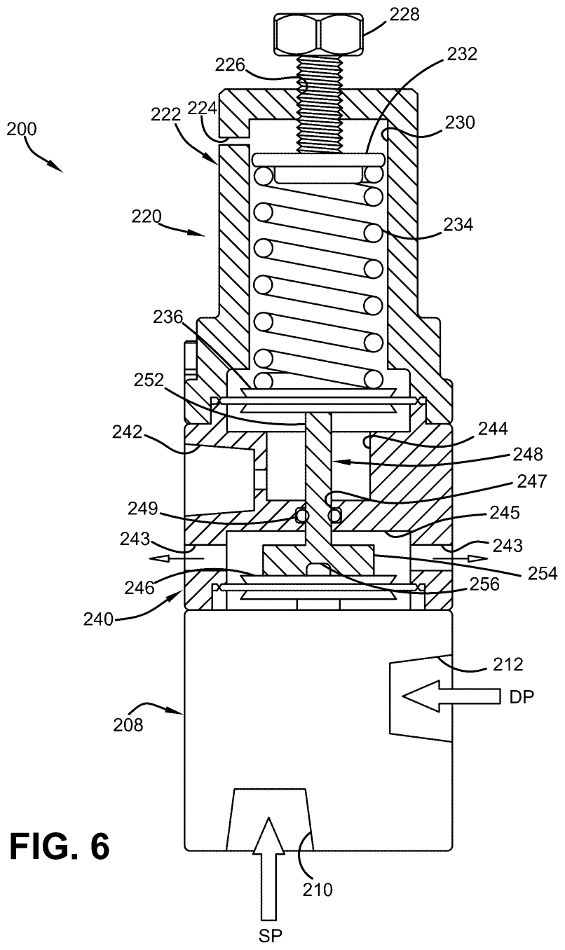

Regulator 200 may also have an exhaust state or condition, as shown in FIG. 6. In the exhaust condition, fluid flow occurs from tire and wheel assembly 19 through delivery port 212 and the valve assembly out of exhaust vents 243, reducing delivery pressure DP, and thus the fluid pressure in the tire and wheel assembly. The exhaust condition of regulator 200 generally occurs when the fluid pressure in tire and wheel assembly 19, and thus delivery pressure DP, is greater than either the ECU-determined optimal pressure for the tire and wheel assembly or the maximum threshold pressure, such as when the tire and wheel assembly becomes heated during operation of the heavy-duty vehicle, increasing fluid pressure within the tire and wheel assembly. Alternatively, the exhaust condition of regulator 200 may be triggered when the ECU determines that the status, condition, or properties of heavy-duty vehicle components require an optimal pressure that is less than the current fluid pressure in tire and wheel assembly 19. In such a case, modulator 100 would introduce control pressure CP, or alter the control pressure transmitted, to pilot chamber 244. As a result, control pressure CP would generate a force against pilot diaphragm 236 that at least partially opposes and/or reduces the force of adjustment screw 228 and spring 234 against the pilot diaphragm, attempting to move the pilot diaphragm upwardly relative to its previous position. The relative upward movement of pilot diaphragm 236 would cause upward movement of plunger 248, reducing the force acting downwardly on regulator diaphragm 246. Regardless of control pressure CP, in the exhaust condition, delivery pressure DP generates a force acting upwardly against regulator diaphragm 246 and overcomes the force established by the adjustment screw 228, spring 234, and pilot diaphragm 236 as applied by plunger 248, deflecting the regulator diaphragm upwardly. Upward deflection of regulator diaphragm 246 causes a component of the valve assembly within regulator section 208 to open a portion of the valve assembly, providing fluid flow from delivery port 212 through the valve assembly and past regulator diaphragm 246. Fluid flow continues past gap 256 of head 254 of plunger 248 into exhaust chamber 245, exiting regulator 200 through exhaust vents 243. The valve assembly in regulator section 208 will continue to provide fluid flow between delivery port 212 and exhaust vents 243 until the force generated by delivery pressure DP acting against regulator diaphragm 246 is in balance with the force generated by adjustment screw 228; spring 234; and pilot diaphragm 236, as reduced by control pressure CP, if introduced into pilot chamber 244, acting through plunger 248 downwardly on the regulator diaphragm.

In the event of an electrical fault or loss of electrical power to tire inflation system 5, the ECU and modulator 100 of tire inflation system 5 would cease operating. As a result, fluid communication from source of fluid pressure 7 to pilot chamber 244 of regulator 200 would cease while any control pressure CP within the regulator would exhaust to atmosphere. However, while modulator 100 would not be able to provide control pressure CP to regulator 200, the regulator would continue to operate regardless. In particular, without control pressure CP, regulator 200 will automatically adjust and maintain fluid pressure in tire and wheel assembly 19 at the maximum threshold pressure set by adjustment screw 228. More particularly, as control pressure CP is exhausted from pilot chamber 244 through pilot conduit portion 11B; modulator 100, and an exhaust conduit 13, the force generated by the control pressure upwardly against pilot diaphragm 236 opposing the force generated by adjustment screw 228 and spring 234 is reduced or eliminated. As a result, the downward deflection of pilot diaphragm 236 is increased, increasing the force acting on stem 252 of plunger 248 and shifting the plunger downward, thereby increasing downward deflection of regulator diaphragm 246. The increased downward deflection of regulator diaphragm 246 causes the response of the valve assembly to delivery pressure DP to change, placing regulator 200 into a supply condition, as discussed above.

Thus, exemplary embodiment heavy-duty vehicle tire inflation system 5, according to the present invention successfully incorporates pilot-operated regulator 200 that automatically and continuously adjusts and maintains fluid pressure in tire and wheel assembly 19 at a maximum threshold pressure, selected using manual operation section 220 of the regulator, in the event of a loss of power to tire inflation system 5, preventing the heavy-duty vehicle from operating with under-inflated tires, thereby increasing fuel economy of the heavy-duty vehicle, preventing damage to, reducing wear on, and increasing the service-life of the tires. Regulator 200 also includes intermediate control section 240 that cooperates with manual operation section 220 and regulator section 208 to provide automatic and continuous adjustment of fluid pressure in tire and wheel assembly 19 in response to control pressure CP, thereby reducing the cost, complexity, and weight of tire inflation system 5.

It is to be understood that tire inflation system 5, according to the present invention, finds application with all types of tire inflation systems, including systems utilized on heavy-duty vehicles with single or dual tire configurations and multiple axles, without affecting the concept or operation of the present invention. It is also to be understood that the structure and operation of modulator 100 and pilot-operated regulator 200, according to the present invention, may be altered or rearranged, or may have certain components omitted or added, without affecting the overall concept or operation. For example, pistons can be utilized in place of pilot and regulator diaphragms 236, 246, respectively, of regulator 200.

Accordingly, tire inflation system 5 of the present invention is simplified; provides an effective, safe, inexpensive, and efficient structure and method, which achieve all the enumerated objectives; provides for eliminating difficulties encountered with prior art tire inflation systems; and solves problems and obtains new results in the art.

In the foregoing description, certain terms have been used for brevity, clarity, and understanding, but no unnecessary limitations are to be implied therefrom beyond the requirements of the prior art because such terms are used for descriptive purposes and are intended to be broadly construed. Moreover, the description and illustration of the invention is by way of example, and the scope of the invention is not limited to the exact details shown or described.

Having now described the features, discoveries, and principles of the invention; the manner in which the tire inflation system is used and installed; the characteristics of the construction, arrangement, and method steps; and the advantageous, new, and useful results obtained, the new and useful structures, devices, elements, arrangements, process, parts, and combinations are set forth in the appended claims.

What is claimed is:

1. A mechanical fluid pressure regulator, said regulator comprising:
a regulator portion for housing components of a valve assembly, said regulator portion having a supply port for receiving a supply pressure and a delivery port for providing a delivery pressure, said delivery port being in selective fluid communication with said supply port;
a pilot port for receiving a control pressure;
at least one exhaust port in selective fluid communication between the delivery port and the external environment;
a first structure disposed within said regulator, said first structure being adjustable for establishing a maximum threshold pressure without regard to said control pressure; and
a second structure disposed within said regulator, said second structure affecting the response of the regulator portion to the supply and delivery pressures;
wherein the control pressure cooperates with the first and second structures to proportionally reduce said delivery pressure from said maximum threshold pressure established by the first structure.

2. The mechanical fluid pressure regulator according to claim 1, said first structure further comprising an adjustment screw threadably disposed through a bonnet of said regulator, said adjustment screw being interconnected with a first piston.

3. The mechanical fluid pressure regulator according to claim 2, said first structure further comprising a spring disposed within said bonnet, said spring operatively engaging said first piston.

4. The mechanical fluid pressure regulator according to claim 3, said first structure further comprising a second piston or first flexible diaphragm operatively engaging said spring, said second piston or first diaphragm preventing fluid communication between the first and second structures.

5. The mechanical fluid pressure regulator according to claim 4, said second structure further comprising a pilot chamber in fluid communication with said pilot port; and
an exhaust chamber in fluid communication with said exhaust port.

6. The mechanical fluid pressure regulator according to claim 5, said second structure further comprising a slidable plunger extending between and at least partially disposed within said pilot chamber and said exhaust chamber.

7. The mechanical fluid pressure regulator according to claim 6, said plunger comprising a stem integrally formed with a head;
wherein said the axial end of said stem operatively engages said second piston or said first diaphragm such that movement of the second piston or first diaphragm causes slidable movement of said plunger.

8. The mechanical fluid pressure regulator according to claim 7, said second structure further comprising a third piston or second flexible diaphragm operatively engaging said head of said plunger;
wherein movement of the plunger causes movement of said third piston or said second diaphragm; and
wherein the third piston or the second diaphragm cooperates with the head of the plunger to provide selective fluid communication between said regulator portion and said exhaust chamber.

9. The mechanical fluid pressure regulator according to claim 8, wherein threading of said adjustment screw in a first direction applies a force to said first piston causing a change in the working height of said spring and relative movement of said second piston or said first diaphragm in said first direction.

10. The mechanical fluid pressure regulator according to claim 9, wherein relative movement of said second piston or said first diaphragm applies a force to and causes relative slidable movement of said plunger in said first direction such that the plunger applies a force to and causes relative movement of said third piston or said second diaphragm in said first direction to alter the response of said regulator portion to said supply pressure and said delivery pressure.

11. The mechanical fluid pressure regulator according to claim 10, wherein said control pressure within said pilot chamber applies a force to said second piston or said first diaphragm in a second direction opposite the first direction to proportionally reduce the relative movement of the second piston or first diaphragm in said first direction such that the proportionally reduced movement in the first direction reduces movement of said plunger and said third piston or said second diaphragm in said first direction, altering the response of said regulator portion to said supply pressure and said delivery pressure.

12. A tire inflation system for heavy-duty vehicles, said tire inflation system comprising:
a source of fluid pressure;
a tire and wheel assembly; and
a mechanical regulator in fluid communication with said source of fluid pressure and said tire and wheel assembly, said mechanical regulator comprising:
a regulator portion for housing components of a valve assembly, said regulator portion having a supply port for receiving a supply pressure and a delivery port for providing a delivery pressure to the tire and wheel assembly, said delivery port being in selective fluid communication with said supply port;
a pilot port for receiving a control pressure;
at least one exhaust port in selective fluid communication between the delivery port and the external environment;
a first structure disposed within said regulator, said first structure being adjustable for establishing a maximum threshold pressure for the tire and wheel assembly without regard to said control pressure; and
a second structure disposed within said regulator, said second structure affecting the response of the regulator portion to the supply and delivery pressures;
wherein the control pressure cooperates with the first and second structures to proportionally reduce said delivery pressure from said maximum threshold pressure established by the first structure.

13. The tire inflation system for heavy-duty vehicles according to claim 12, said tire inflation system further comprising a wheel valve in fluid communication with said mechanical regulator and said tire and wheel assembly.

14. The tire inflation system for heavy-duty vehicles according to claim 13, said tire inflation system further comprising an electronically controlled modulator in fluid communication with said source of fluid pressure and said mechanical regulator.

15. The tire inflation system for heavy-duty vehicles according to claim 14, said modulator providing said control pressure to said mechanical regulator to proportionally reduce said delivery pressure to said tire and wheel assembly from the maximum threshold pressure to an optimal value for a particular condition of one or more components of the heavy-duty vehicle.

16. The tire inflation system for heavy-duty vehicles according to claim 15, wherein a loss of electrical power to said tire inflation system deactivates said modulator, exhausting said control pressure from the modulator and said mechanical regulator;
wherein said delivery pressure to said tire and wheel assembly defaults to the maximum threshold pressure established by said first structure.
